(19) United States
(12) Patent Application Publication
(10) Pub. No.: US 2010/0090798 A1
(43) Pub. Date: Apr. 15, 2010

(54) TEMPLATE SYNTHESIS FOR ECG/PPG BASED BIOMETRICS

(75) Inventors: Gary Nelson Garcia Molina, Eindhoven (NL); Alphons Antonius Maria Lambertus Bruekers, Eindhoven (NL); Cristian Presura, Eindhoven (NL); Marijn Christian Damstra, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/442,754

(22) PCT Filed: Sep. 25, 2007
(86) PCT No.: PCT/IB07/53880

§ 371 Date: Mar. 25, 2009

(30) Foreign Application Priority Data
Sep. 29, 2006 (EP) 06121504.2

(51) Int. Cl. G06K 9/00

(52) U.S. Cl. 340/5.53

(57) ABSTRACT

The present invention relates to a method and a device for verifying identity of an individual by employing biometric data derived from a physical feature of the individual. A basic idea of the invention is that, rather than determining peak locations in cyclic signals such as ECG or PPG signals when using these signals as a representation of biometric data for verifying identity of an individual, shape or morphology of the signals is considered.

### TECHNICAL FIELD OF THE PRESENT INVENTION

The present invention relates to a method and a device for verifying identity of an individual by employing biometric data derived from a physical feature of the individual.

### BACKGROUND ART

Authentication of physical objects may be used in many applications, such as conditional access to secure buildings or conditional access to digital data (e.g. stored in a computer or removable storage media), or for identification purposes (e.g. for charging an identified individual for a particular activity).

The use of biometrics for identification and/or authentication is to an ever-increasing extent considered to be a better alternative to traditional identification means such as passwords and pin-codes. The number of systems that require identification in the form of passwords/pin-codes is steadily increasing and, consequently, so is the number of passwords/pin-codes that a user of the systems must memorize. In biometric identification, features that are unique to a user such as fingerprints, irises, ears, faces, etc. are used to provide identification of the user. Clearly, the user does not lose or forget his/her biometric features, neither is there any need to write them down or memorize them.

When identifying or authenticating a user, a biometric feature of the user is compared to reference data. If a match occurs, the user is considered to be identified/authenticated. The reference data for the user has been obtained earlier during a so-called enrolment phase and is stored, e.g. in a database or smart card. Enrolment is thus the initial process when an enrolment authority acquires a biometric template of a user, i.e. the user offers her biometric data to an enrolment device of the enrolment authority, which processes the biometric data to extract and store a feature set. The stored feature set of the individual is referred to as the individual's biometric template. During verification, i.e. when identifying or authenticating the user, she again offers her biometric data to the system which processes the data and creates a template, wherein the stored template is retrieved (and decrypted if required) and matching of the stored and the offered template is effected.

Identification can also be achieved by processing electrocardiogram (ECG) signals which reflect electrical activity of the heart. This is done by analyzing characteristics of typical cycles (PQRST cycles) forming the ECG. These signals are mainly used for diagnosis, and appear to vary from person to person according to different factors such as anatomic differences in the heart, gender, relative body weight, chest configuration, etc. Blood flow waveforms which are related to ECGs can also be used for identification. Photoplethysmography (PPG) is a method used to monitor blood flow, which method detects perfusion of blood through tissue by illuminating the tissue and measuring reflected light. The resulting signal is called a photoplethysmogram.

In current approaches of using ECG-based biometric data for identification, the biometric template of the individual is extracted from a PQRST cycle, taking relative location and amplitudes of P, Q, R, S and T peaks of the PQRST cycle into particular consideration. Such an approach is disclosed in “ECG Analysis: A New Approach in Human Identification”, by L. Biel, O. Pettersson, L. Philipson, and P. Wide, IEEE Transactions on Instrumentation and Measurement, vol. 50, no. 3, pp. 808.812, 2001.

In practice, the PQRST peaks cannot be precisely determined in an automated way. Indeed, certain ECGs do not exhibit all these peaks (e.g. when certain electrode configurations are used or in pathological cases). Further, a finite sampling frequency and errors in the detection procedure contribute to uncertainty in the determination of the locations of the peaks.

The biometric template must be corrected for heart-rate variability, which is particularly important when the heart-rate during enrolment differs from the one exhibited during verification. Since a template offered during verification never will be exactly the same as the enrolled template, a user may very well be rejected even though she in fact should be authorized. Hence, it is desirable not to erroneously reject authorized individuals, i.e. a low false rejection rate (FRR) is required. On the contrary, an individual should not be incorrectly authorized, i.e. a low false acceptance rate (FAR) is required. A trade-off must be made between these two parameters. In an ideal setting, the biometric template consists of feature sets that are extracted during enrollment at every possible heart-rate. However, it is inconvenient and, in practice, infeasible to create such an exhaustive set of features during enrolment.

### SUMMARY OF THE INVENTION

An object of the present invention is to overcome above mentioned problems relating to prior art biometric identification systems.

This object is attained by a method of verifying identity of an individual by employing biometric data derived from a physical feature of the individual in accordance with claim 1 and a device for verifying identity of an individual by employing biometric data derived from a physical feature of the individual in accordance with claim 9.

Preferred embodiments are defined by dependent claims.

In a first aspect of the invention, a method is provided comprising the steps of acquiring a signal representing said biometric data and normalizing the acquired signal using a value of at least one predetermined property of the signal as normalization parameter. Further, a candidate signal is synthesized using at least two signals selected from a group consisting of the normalized acquired signal and at least two different previously enrolled signals representing biometric data, which previously enrolled signals are normalized using the normalization parameter, by means of employing a function of a value of the predetermined property as a synthesis parameter. Finally, the method comprises the step of determining whether the synthesized candidate signal corresponds to any one of the remaining signals in the group, which normalized acquired signal either is used when synthesizing the candidate signal or constituting the remaining signal, wherein the identity of the individual is verified if there is correspondence between the synthesized candidate signal and said any one of the remaining signals.

In a second aspect of the invention, a device is provided comprising means for acquiring a signal representing said biometric data and means for normalizing the acquired signal using a value of at least one predetermined property of the signal as normalization parameter. Further, the device comprises means for synthesizing a candidate signal using at least two signals selected from a group consisting of the normalized acquired signal and at least two different previously enrolled signals representing biometric data, which previously enrolled signals are normalized using the normalization parameter, by means of employing a function of a value of the predetermined property as a synthesis parameter. Moreover, the device comprises means for storing the enrolled signals and means for determining whether the synthesized candidate signal corresponds to any one of the remaining signals in the group, which normalized acquired signal either is used when synthesizing the candidate signal or constituting the remaining signal, wherein the identity of the individual is verified if there is correspondence between the synthesized candidate signal and said any one of the remaining signals.

A basic idea of the invention is that, rather than determining peak locations in cyclic signals such as ECG or PPG signals when using these signals as a representation of biometric data for verifying identity of an individual, shape or morphology of the signals is considered. In PQRST cycles forming an ECG, the morphology of R-R segments can be used as a means for comparison between a biometric measurement and a biometric template. Whereas the relative location of distinctive patterns in a PQRST cycle can change, the morphology of R-R segments remains essentially unchanged. Typically, the R-peaks are taken as reference because they are present in every electrode configuration and can be more precisely and unambiguously determined as they constitute the highest peaks in the ECG signal. Also, all the elements of a PQRST-cycle are contained within an R-R segment. Even though identification of an individual by means of extracting feature data sets from the R-R segment is discussed throughout this description, it should be clearly understood by a skilled person that other segments could be considered, as well as other suitable signals from which the segments are selected. Further, to improve performance of the biometric identification, a sequence of R-R segments may be employed in the verification procedure.

To enable verification of the identity of an individual by employing biometric data derived from a physical feature of the individual, a measurement is taken of the physical feature in question, e.g. the ECG of the individual. A signal in the form of an ECG is thus created in this particular example. This signal consists of a plurality of PQRST cycles, which cycles represent biometric data of the individual. In an exemplifying embodiment of the invention, the ECG signal is digitized and segmented into R-R segments, even though segmentation is optional for the invention. Because of heart-rate variability of the individual, the R-R segments in an ECG recording have different durations. Hence, for two different measurements of the ECG of the same individual, the PQRST cycle may vary in length, which has as an effect that the two measurements will comprise a different number of samples given that the sample frequency is the same. To overcome this problem, the R-R segment is normalized with respect to its length (i.e. the number of samples forming the R-R segment). It should be noted that the signal can be normalized with respect to some other property of the signal, such as amplitude, energy etc. Further, a combination of properties may be used in the normalization procedure. However, in this particular example, each R-R segment recorded during verification is normalized to comprise the same predetermined number of samples, i.e. a predetermined value L is used for the normalization parameter.

Prior to verification of the identity of the individual, the individual has been enrolled in the system in that at least two segments of the signal representing the biometric data have been recorded and stored. This is typically referred to as the biometric template of the individual. A candidate segment is morphologically synthesized using these at least two segments after they have been normalized. This normalization is performed using the same value L of the property used when normalizing the signal that was attained during verification. That is, since the R-R segment recorded during verification is normalized with respect to its length using the value L, the enrolled segments will also be normalized using the value L. In the synthesis procedure, a function of a value of the property used in the normalization is employed. Assuming that the signal recorded during verification is normalized with respect to its length using a length normalization parameter L (which is also used when normalizing the enrolled signals), then a function of this property is used when performing synthesis. For instance, the actual length p of the R-R segment recorded during verification can be employed. Finally, it is determined whether the normalized segment to be verified corresponds to the synthesized enrolled segment. If the two segments are considered to resemble each other to a certain extent, the identity of the individual is verified. This determination can be made by using e.g. the so called l₂-norm to attain a “similarity score”. To decide the authenticity of the claimed identity, this score is usually compared to a threshold value.

Alternatively, a candidate segment is morphologically synthesized using at least one of the enrolled segments (after is has been normalized) and the normalized segment attained during verification, again utilizing e.g. the actual length of the segment attained during verification as a synthesis parameter. Thereafter, a check for correspondence is made using the synthesized candidate segment and a remaining one of the normalized enrolled segments.

As can be seen, the segment attained and normalized during verification must either:
1) be used when synthesizing a candidate segment or (if it is not used during synthesis)
2) compared to the synthesized candidate segment when checking for correspondence.

Since the two segments which ultimately are to be compared for resemblance are of the same length after normalization, they can readily be compared using e.g. lₚ distance. The morphological synthesis is implemented by using the notion of time normalization (or alignment) for comparing at least two segments. Time normalization is essentially used to match univariate or multivariate time sequences that do not evolve at the same pace. Time normalization algorithms include linear time normalization and dynamic time warping (DTW). The latter is used here. Advantageously, biometric identification in accordance with the present invention enables usage of as few as two enrolled biometric templates and one biometric template provided during verification for synthesizing a candidate biometric template to be used for verifying the identity of an individual. Preferably, even though not strictly necessary, the at least two enrolled segments are taken from two ECGs exhibiting extreme lengths, in the particular example where ECGs are used in the biometric identification process. Hence, one enrolled biometric template is derived from an ECG exhibiting a low heart-rate (i.e. a “long” segment with respect to number of samples) while the other is derived from an ECG exhibiting a high heart-rate (i.e. a “short” segment with respect to number of samples). This suggest that building a biometric model for synthesis only requires two R-R segments whose lengths lie at the respective extreme. A possible enrolling strategy can consist in eliciting low and high heart-rates through relaxation and physical activity.

It should be noted that other signals representing biometric data can be used for identifying an individual in accordance with the invention. In a first example, the biometric which used is a fingerprint, and the property of the signal used in the normalization and synthesis procedure is the pressure applied by the individual to the sensor recording the actual fingerprint. In a second example, the biometric used is the appearance of an individual's walking style. In such an example, the individual is filmed and the pace and/or rhythm of the individual when walking is used as normalization and synthesis parameters.

Further features of, and advantages with, the present invention will become apparent when studying the appended claims and the following description. Those skilled in the art realize that different features of the present invention can be combined to create embodiments other than those explicitly described in the following.

### BRIEF DESCRIPTION OF THE DRAWINGS

A detailed description of preferred embodiments of the present invention will be given in the following with reference made to the accompanying drawing, in which:

FIG. 1 shows an electrocardiogram in which a PQRST cycle is indicated;

FIG. 2 shows a system for verifying identity of an individual in accordance with an embodiment of the invention; and

FIG. 3 shows segmentation and pre-processing of a signal.

### DETAILED DESCRIPTION OF EMBODIMENTS OF THE INVENTION

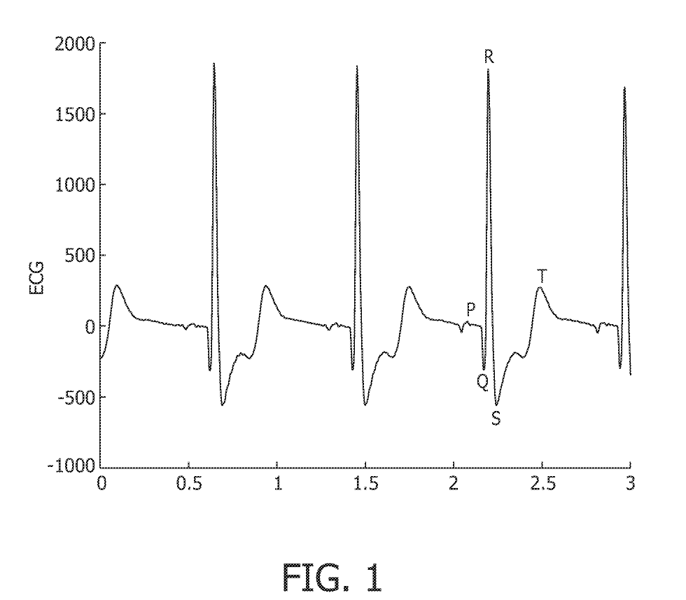

FIG. 1 shows an illustration of a recorded ECG, where a so called PQRST cycle has been indicated. As previously has been discussed, characteristics of PQRST cycles can be employed for extracting feature sets, or biometric templates, of an individual. Rather than determining the location of peaks in the PQRST cycle, shape of R-R segments can be used for biometric identification.

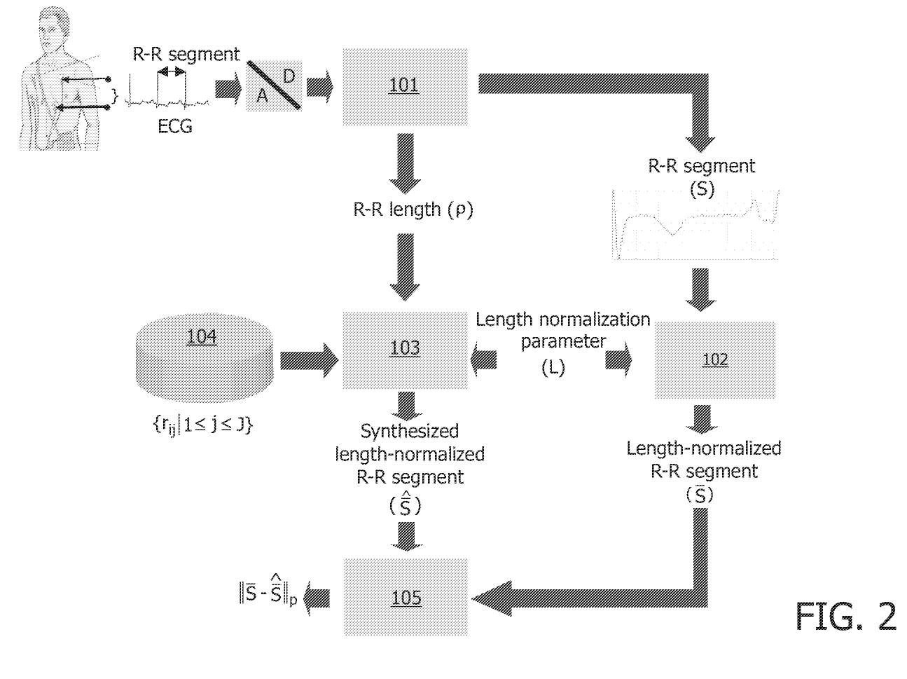

FIG. 2 shows a system for verifying identity of an individual in accordance with an embodiment of the invention. In the system, a digitized ECG signal is segmented by segmentation block 101. From the R-R segment S, the actual length ρ of the segment is derived. The R-R segment S is length-normalized to contain L samples by normalization block 102. L is thus referred to as the normalization parameter. In FIG. 2, the length-normalized R-R segment is output by normalization block 102 and denoted S̅. The length normalization parameter L is further used as input together with the actual length ρ of the R-R segment to synthesis block 103. Hence, even though an R-R segment to be verified comprises e.g. 250 samples and a previously enrolled R-R segment comprises e.g. 320 samples, the two R-R segments are normalized such that they both comprise the same number samples, say 300.

For each individual to be identified, at least two enrolled biometric templates extracted from two different R-R segments denoted r₁ and r₂ are stored in database 104. As is discussed in the above, these two R-R segments may be taken from two ECGs exhibiting extreme lengths. rᵢ denotes an enrolled segment of a particular individual i and J is the number of segments enrolled for the individual.

In synthesis block 103, a length-normalized segment ŝ̅ is synthesized using two segments selected from a group consisting of the two segments r₁ and r₂ and the segment S̅ from normalization block 102. Of course, database 104 may contain further enrolled segments of the individual to be identified, in which case more than two segments may be used in the synthesis. In this particular example, r₁ and r₂ are employed in the synthesis process. Finally, the synthesized segment Ŝ̅ and the segment S̅ from normalization block 102 are supplied to comparison block 105. Since the two segments have the same length, they can be readily compared using e.g. the lₚ distance. If the two segments are considered to resemble each other to a certain extent, the identity of the individual is verified.

Hence, in the embodiment of the present invention described with reference made to FIG. 2, using the length ρ of a current R-R segment, the normalization parameter L and the biometric templates r₁ and r₂, a length-normalized R-R candidate segment denoted as Ŝ̅ is synthesized.

The different functional blocks shown in the system of FIG. 2 are typically implemented by means of a microprocessor or some other appropriate device with computing capabilities, such as an ASIC (Application Specific Integrated Circuit), an FPGA (Field Programmable Gate Array), a CPLD (Complex Programmable Logic Device), etc. The system could further advantageously be implemented in a single device such as a mobile phone or even a smart card. Possibly, such a device may have to be provided with a sensor for measuring heart-rates. Further, the device comprises storing means and is typically arranged with an analog-digital converter, as is shown in FIG. 2, for converting measured analog values into digital bit strings for further processing. When performing steps of different embodiments of the method of the present invention, the microprocessor typically executes appropriate software that is downloaded to the device and stored in the storing means.

In the following, the synthesis process is described in detail. The process of morphologically synthesizing R-R segments is formalized as follows. Given a set of R-R templates sharing a common morphology {r_{i,j}|1≦j≦J}, i.e. the templates associated with subject i, with respective lengths {ρ_{i,j}|ρ_{i,j}<ρ_{i,j+1}} and ρ ∉{ρ_{i,j}}, a normalized R-R segment Ŝ̅ᵢ of length L that has the same morphology as the elements in { r̅_{i,j}} should be generated. The case ρ ε {ρ_{i,j}} is trivial as Ŝ̅ᵢ is equal to r̅_{i,j} such that ρ_{i,j}=ρ. The morphological synthesis problem is solved using notion of time normalization (or alignment) for comparing two signals. Time normalization is essentially used to match univariate or multivariate time sequences that do not evolve at the same pace. Time normalization algorithms include linear time normalization and dynamic time warping (DTW). The latter is used here. DTW has been mainly used for spectral sequence comparison of speech signals to compute a distance measure between a reference signal and a test signal. To this end, all possible sample-to-sample absolute differences between these signals are computed and their distance is defined as the accumulated absolute difference along the minimum difference path (DTW-path). The monotonically increasing DTW-path aligns the matching temporal patterns between the reference and test signals.

Since the DTW-path denoted P _{x̅1, y̅2} aligns matching temporal patterns, the relations in (1) below hold. The indices n and m are used to refer to the samples of x̅₁ (reference signal) and x̅₂ (test signal), respectively.

\overline{\hat{x}}₂(m)= x̅₁(n)

n=P _{x̅1, x̅2}(m)

[symbol]

\overline{\hat{x}}₂(m)= x̅₁(P _{x̅1, x̅2}(m)); m=1, . . . , L. (1)

where \overline{\hat{x}}₂(m) is an estimate of x̅₂(m). In accordance with (1), an estimate for the test signal x̅₂ can be obtained from the reference signal x̅₁ and the path P _{x̅1, x̅2}. Because of its temporal nature the path P _{x̅1, x̅2} is assumed to be monotonic. The relations in (1) serve as basis for synthesizing Ŝ̅ᵢ from {r_{i,j}}. By arbitrarily choosing a reference template r_{i,k} in {r_{i,j}}, the following holds:

ŝ̅ᵢ(m)= r̅_{i,k}(P _{r̅}_{_{i,k}}_{, s̅}_{ᵢ}(m)); m=1, . . . L. (2)

The DTW-path P _{r̅}_{_{i,k}}_{, s̅}ᵢ an be estimated from the inter-template paths P _{r̅}_{_{i,k}}_{, r̅}_{_{i,l}}, . . . , P _{r̅}_{_{i,k}}_{, r̅}_{_{i,j}} through a functional F:

\hat{P}ᵣ_{_{i,k}}_{,s}ᵢ= [symbol] (Pᵣ_{_{i,k}}_{,r}_{_{i,l}}, . . . , Pᵣ_{_{i,k}}_{,r}_{_{i,j}}). (3)

A particular choice for F, which is adopted here, corresponds to the linearly weighted estimation (4).

$${\hat{P}}_{{\overline{r}}_{i , k} , {\overline{s}}_{i}} ( m ) = {\sum }_{j = 1}^{J} {α}_{i , j} {P}_{{\overline{r}}_{i , k} , {\overline{r}}_{i , j} ( m )} ; {α}_{i , j} ∈ ℝ \qquad ( 4 )$$

The monotonicity of \hat{P}ᵣ_{_{i,k}}_{,s}_{ᵢ} can be ensured by constraining the weighting coefficients α_{i,j} or by post-processing. A possible form of post-processing can be defined as follows:

$${\hat{P}}_{{\overline{r}}_{i , k} , {\overline{s}}_{i}}^{′} ( m ) = 〚 {\sum }_{j = 1}^{J} {α}_{i , j} {P}_{{\overline{r}}_{i , k} , {\overline{r}}_{i , j}} ( m ) 〛 \\ {\hat{P}}_{{\overline{r}}_{i , k} , {\overline{s}}_{i}} ( m ) = max ( {\hat{P}}_{{\overline{r}}_{i , k} , {\overline{s}}_{i}} ( m - 1 ) , {\hat{P}}_{{\overline{r}}_{i , k} , {\overline{s}}_{i}}^{′} ( m ) ) , \qquad ( 5 )$$

By employing (2):

ŝ̅ᵢ(m)= r̅_{i,k}(\hat{P}ᵣ_{_{i,k}}_{,s}_{ᵢ}(m)). (6)

A possible approach for obtaining the linear combination coefficients α_{i,j} consists in using the Lagrange interpolation formula:

$${α}_{i , j} = {\prod }_{i \neq j}^{ } \frac{ρ - {ρ}_{i , l}}{{ρ}_{i , j} - {ρ}_{i , l}} \qquad ( 7 )$$

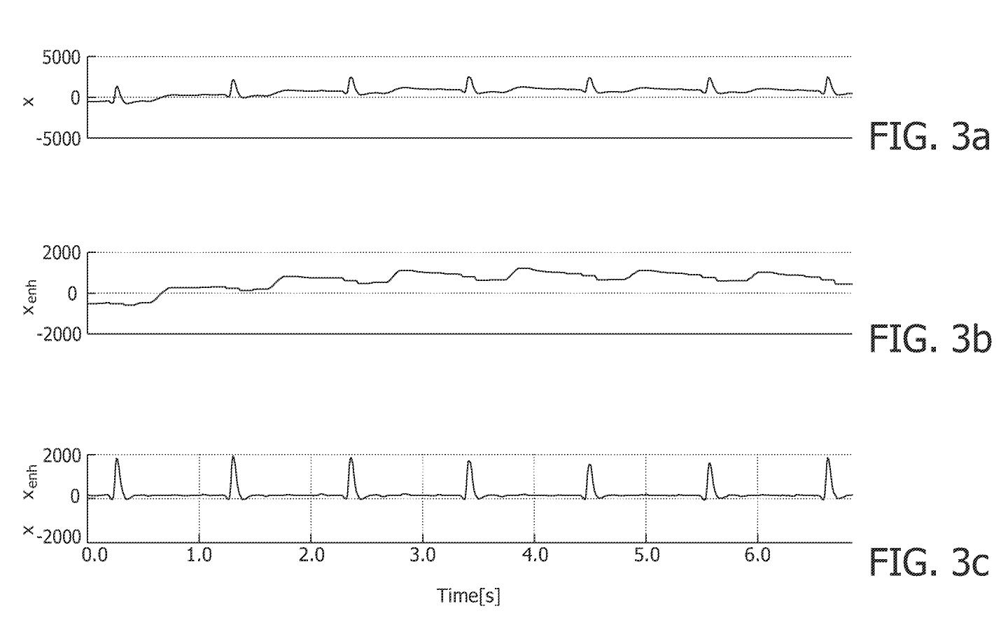

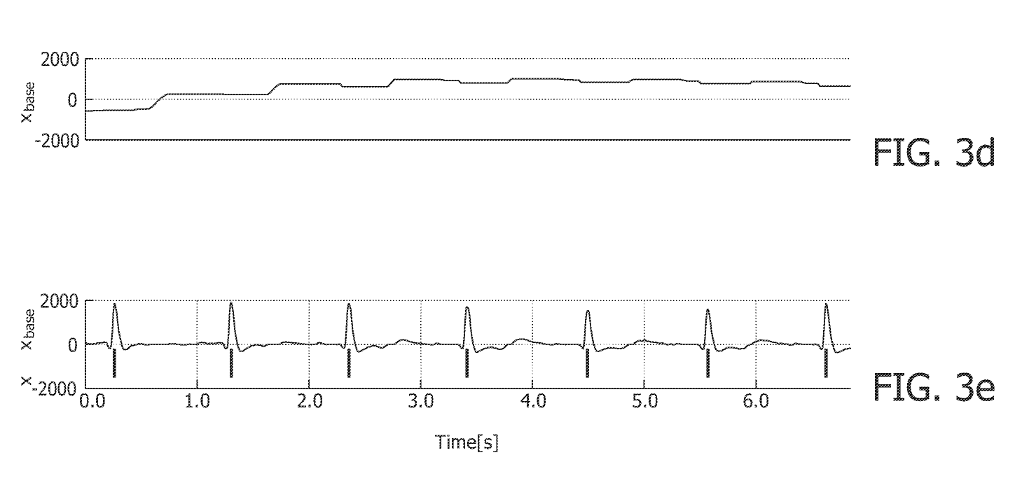

Now, with reference to FIG. 3, segmentation (which was described in connection to FIG. 2) and pre-processing of a segmented signal will be described in some more detail. ECG signals can have artefacts due to external noise sources (e.g. power line), baseline drifts, and subject movement. Thus, prior to detecting the R-peaks, a Savitzky-Golay (SG) time-domain smoothing filter can be used. This filter can be considered as frame-by-frame least squares fitting of a polynomial function to the signal. Identification of constitutive elements of a PQRST cycle constitutes a fundamental step in ECG analysis because it serves as the basis for clinical diagnosis, precise heart rate determination, ECG data compression, and cardiac cycle classification. Mathematical-morphology (MM) based algorithms is advantageously used since they can remove very low frequency components (baseline drifts), do not require any specific assumptions other than the sharpness of the peaks and valleys of the PQRST-cycle, and are computationally efficient. In FIG. 3a, a “raw” ECG signal (x) is shown. An R-peak enhancing signal (xenh) is then derived (shown in FIG. 3b) which is subtracted from x to obtain the R-peak enhanced signal in FIG. 3c. The latter allows for straightforward R-peak detection using thresholding. Subsequently, a baseline correcting signal (xbase) is calculated (FIG. 3d) which is subtracted from x to derive the baseline corrected signal in FIG. 3e. The positions of the R-peaks are indicated by the bold vertical lines of FIG. 3e.

Even though the invention has been described with reference to specific exemplifying embodiments thereof, many different alterations, modifications and the like will become apparent for those skilled in the art. The described embodiments are therefore not intended to limit the scope of the invention, as defined by the appended claims.

1. A method of verifying identity of an individual by employing biometric data derived from a physical feature of the individual, the method comprising the steps of:
acquiring a signal representing said biometric data;
normalizing the acquired signal using a value of at least one predetermined property of the signal as normalization parameter;
synthesizing a candidate signal using at least two signals selected from a group consisting of said normalized acquired signal and at least two different previously enrolled signals representing biometric data, which previously enrolled signals are normalized using said normalization parameter, by means of employing a function of a value of said predetermined property as a synthesis parameter; and
determining whether the synthesized candidate signal corresponds to any one of the remaining signals in said group, said normalized acquired signal either being used when synthesizing the candidate signal or constituting said remaining signal, wherein the identity of the individual is verified if there is correspondence between the synthesized candidate signal and said any one of the remaining signals.

2. The method of claim 1, wherein the synthesis of the candidate signal is performed by using at least two of the different previously enrolled signals and the identity of the individual is verified if there is correspondence between the synthesized candidate signal and the normalized acquired signal.

3. The method of claim 1, wherein the synthesis of the candidate signal is performed by using the normalized acquired signal and at least one of the different previously enrolled signals and the identity of the individual is verified if there is correspondence between the synthesized candidate signal and a remaining one of said at least two different previously enrolled signals.

4. The method of claim 1, wherein the normalization is achieved by means of curve fitting.

5. The method of claim 1, wherein the normalization is achieved by means of interpolation.

6. The method according to claim 1, wherein the signal representing biometric data comprises a cardiac signal.

7. The method according to claim 1, wherein a segment of the signal representing biometric data is acquired and a segment of the respective at least two enrolled signals are employed in the synthesis.

8. The method according to claim 7, wherein the segment of the signal is an R-R segment of a cardiac signal.

9. A device for verifying identity of an individual by employing biometric data derived from a physical feature of the individual, the device comprising:
means (104) for acquiring a signal representing said biometric data;
means (102) for normalizing the acquired signal using a value of at least one predetermined property of the signal as normalization parameter;
means (103) for synthesizing a candidate signal using at least two signals selected from a group consisting of said normalized acquired signal and at least two different previously enrolled signals representing biometric data, which previously enrolled signals are normalized using said normalization parameter, by means of employing a function of a value of said predetermined property as a synthesis parameter;
means (104) for storing the enrolled signals; and
means (105) for determining whether the synthesized candidate signal corresponds to any one of the remaining signals in said group, said normalized acquired signal either being used when synthesizing the candidate signal or constituting said remaining signal, wherein the identity of the individual is verified if there is correspondence between the synthesized candidate signal and said any one of the remaining signals.

10. The device of claim 9, wherein said means (103) for synthesizing the candidate signal uses at least two of the different previously enrolled signals and the identity of the individual is verified by the determining means (105) if there is correspondence between the synthesized candidate signal and the normalized acquired signal.

11. The device of claim 9, wherein said means (103) for synthesizing the candidate signal uses the normalized acquired signal and at least one of the different previously enrolled signals and the identity of the individual is verified the determining means (105) if there is correspondence between the synthesized candidate signal and a remaining one of said at least two different previously enrolled signals.

12. The device of claim 9, further comprising means (101) for segmenting the acquired signal and the storing means (104) comprises corresponding segments of the enrolled signals.

13. A computer program product comprising executable components for causing a device having computing capabilities to perform the steps recited in claim 1 when the components are executed in said device.
